(19) United States
(12) Patent Application Publication
(10) Pub. No.: US 2006/0223395 A1
(43) Pub. Date: Oct. 5, 2006

(54) Skidproof mat

(76) Inventor: Guanghe Wang, Shenzhen (CN)

Correspondence Address: HAMRE, SCHUMANN, MUELLER & LARSON, P.C., P.O. BOX 2902-0902, MINNEAPOLIS, MN, 55402, US

(21) Appl. No.: 11/395,726

(22) Filed: Mar. 31, 2006

(30) Foreign Application Priority Data
Apr. 1, 2005 (CN) 200520056309.9

(51) Int. Cl. B32B 27/04; B32B 27/12; B32B 5/02

(52) U.S. Cl. 442/38; 442/101

(57) ABSTRACT

A skidproof mat is provided which comprises: a rubber layer; and a base layer; wherein said base layer is arranged in said rubber layer. In accordance with the present invention, the rubber layer is made of thermoplastic elastic materials such as thermo plastic rubber and thermo plastic elastomer, which ensures perfect anti-slip effect. The base layer is positioned in the rubber layer to increase the tenacity so that the skidproof mat is impossible to be deformed and has well ageing resistance. In addition it is convenient to print various required patterns on the base layer.

### BACKGROUND OF THE INVENTION

1. Field of the Invention

The present invention relates to a skidproof mat, and more especially to a skidproof mat used under wildly rocking environment.

2. Description of the Prior Art

Known skidproof mats are normally used in daily house life and under wildly rocking environment such as vehicles, ship, trains and airplanes. A published Chinese utility model patent with the Pat. No. ZL 99251268.9 discloses a skidproof mat applied in daily house life which is available on a smooth floor or a surface of a bathtub to prevent people from slipping. The objects placed in a relatively wobbling environment also require a skidproof mat to remain stability. For example, a mobile phone, a key or a perfume bottle arranged on an instrument table of a car without the skidproof mat is unable to ensure steady just like jamming the brakes on or having a bumpy ride. Moreover, the skidproof mat above-mentioned generally has a drawback of poor surface viscosity, so it is not available under wildly rocking environment.

Recently a kind of skidproof mat made of thermoplastic elastic materials like TPR (thermo plastic rubber) or TPE (thermo plastic elastomer) appears. Since the TPR and TPE have perfect viscosity, this skidproof mat can provide better effect of anti-slip or . However, it is difficult to print patterns or trademarks, even other individual information such as advertisements thereon, resulting in failing to meet actual requirements of clients. In addition, this skidproof mat is prong to be deformed for the reason of its softy property

### BRIEF SUMMARY OF THE INVENTION

A primary object of the present invention is to provide a method for manufacturing a decorative stone which increases the decorative effect through inlaying different pattern and specificity stones.

To achieve the above-mentioned object, a skidproof mat is provided which comprises: a rubber layer; and a base layer; wherein said base layer is arranged in said rubber layer.

Advantageously, said base layer is made of fiber clothes, wire meshes, plastic films or screens.

Advantageously, said rubber layer is made of thermoplastic elastic materials. Advantageously, said thermoplastic elastic material is thermo plastic rubber or thermo plastic elastomer.

Advantageously, said skidproof mat further includes a protection film covering said rubber layer.

In accordance with the present invention, the rubber layer is made of thermoplastic elastic materials such as thermo plastic rubber and thermo plastic elastomer, which ensures perfect anti-slip effect. The base layer is positioned in the rubber layer to increase the tenacity so that the skidproof mat is impossible to be deformed and has well ageing resistance. In addition it is convenient to print various required patterns on the base layer.

Other objects, advantages and novel features of the present invention will become more apparent from the following detailed description when taken in conjunction with the accompanying drawings, in which:

### BRIEF DESCRIPTION OF THE DRAWINGS

FIG. 1 is a longitudinal cross-sectional view in accordance with the present invention.

### DETAILED DESCRIPTION OF THE INVENTION

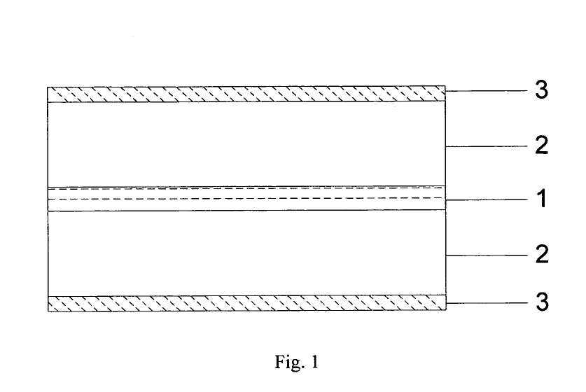

Referring to FIG. 1, a skidproof mat according to the present invention includes a base layer 1 and a rubber layer 2, wherein the base layer 1 is sandwiched between the rubber layer 2. The base layer 1 is made of fiber clothes, wire meshes, plastic films or screens. The rubber layer 2 is made of thermoplastic elastic materials for instance, TPR (thermo plastic rubber) or TPE (thermo plastic elastomer). The rubber layer 2 is distributed evenly on a top and bottom surface of the base layer 1 after melted by high temperature.

TPR or TPE has good elasticity, high intensity and perfect viscosity, so it can provide excellent anti-slip performance. It is also easy to be machined as various shape to satisfy actual requirements of people. The skidproof mat in accordance with the present invention defines the base layer 1 between the rubber layer 2, which increases the tenacity of the skidproof mat having such structure. Thus, the skidproof mat is impossible to be deformed and has well ageing resistance. Additionally, it is convenient to print various required patterns on the base layer 1 and it is also advantageous if change the patterns. As a result, this skidproof mat has high utility in actual manufacture.

Furthermore, the rubber layer 2 is prone to be polluted since it has high viscosity. So the skidproof mat in accordance with the present invention further includes a protection film covering the rubber layer 2, for decreasing pollution during manufacture process and ensuring perfect performance of products.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A skidproof mat comprising:
a rubber layer; and
a base layer;
wherein said base layer is arranged in said rubber layer.

2. The skidproof mat as claimed in claim 1, wherein said base layer is made of fiber clothes, wire meshes, plastic films or screens.

3. The skidproof mat as claimed in claim 1, wherein said rubber layer is made of thermoplastic elastic materials.

4. The skidproof mat as claimed in claim 3, wherein said thermoplastic elastic material is thermo plastic rubber or thermo plastic elastomer.

5. The skidproof mat as claimed in claim 1, wherein said skidproof mat further includes a protection film covering said rubber layer.

6. A skidproof mat comprising:
a rubber layer; and
a base layer;
wherein said base layer is sandwiched in said rubber layer.

7. The skidproof mat as claimed in claim 6, wherein said base layer is made of fiber clothes, wire meshes, plastic films or screens.

8. The skidproof mat as claimed in claim 6, wherein said rubber layer is made of thermoplastic elastic materials.

9. The skidproof mat as claimed in claim 8, wherein said thermoplastic elastic material is thermo plastic rubber or thermo plastic elastomer.

10. The skidproof mat as claimed in claim 6, wherein said skidproof mat further includes a protection film covering said rubber layer.
